(19) United States
(12) Patent Application Publication
(10) Pub. No.: US 2011/0094976 A1
(43) Pub. Date: Apr. 28, 2011

(54) MOTORCYCLE STAND

(76) Inventors: Michael J. Pratt, Draper, UT (US); Seth C. Lytle, American Fork, UT (US); David W. Bradley, Lehi, UT (US)

(21) Appl. No.: 12/683,323

(22) Filed: Jan. 6, 2010

Related U.S. Application Data
(60) Provisional application No. 61/143,278, filed on Jan. 8, 2009.

(51) Int. Cl. B62H 3/08

(52) U.S. Cl. 211/20

(57) ABSTRACT

A simple-to-use motorcycle stand does not require any moving parts, and adequately supports a motorcycle in an upright position. The motorcycle is simply pushed forward onto the stand and pulled backward off the stand causing rotational movement of at least a portion of the stand, which may include some translational movement of the stand across an underlying surface. The stand includes one or more structures that engage portions of the motorcycle as the motorcycle is pushed into the stand, thereby causing the rotational movement. As the motorcycle continues moving forward over the stand, the one or more structures engage the body of the motorcycle behind the front wheel, supporting the motorcycle in an upright position. Meanwhile an opposite side of the stand engages the ground. The entire process for engaging or disengaging the stand can be accomplished in one smooth movement of pushing the motorcycle forward or backward.

### CROSS-REFERENCE TO RELATED APPLICATIONS

This application claims the benefit of U.S. Provisional Application No. 61/143,278 filed Jan. 8, 2009.

### BACKGROUND OF THE INVENTION

1. Field of the Invention

The present invention relates to motorcycle stands, and more particularly to a rotating dirt bike stand configured to rotate into a supporting position as a dirt bike-type motorcycle or the like is pushed into the stand.

2. Background and Related Art

Some motorcycles, such as dirt bikes, do not include an attached stand such as a kick stand. While the lack of an attached stand serves to protect the rider of the dirt bike from accident or injury during riding including extreme riding (e.g. motocross, performance of tricks, and the like), the lack of an attached stand can be bothersome when the motorcycle rider wishes to dismount the motorcycle and leave the motorcycle, the rider is forced to either lay the motorcycle down on its side, lean it against a sturdy object, or utilize a stand-alone motorcycle stand. Similar problems are encountered when the motorcycle is to be worked on, as it is commonly advantageous to work on the motorcycle in an upright position.

Many stand-alone motorcycle stands are either difficult to use, are cumbersome, or include multiple moving parts that are prone to breakage during use. Such stands utilize a variety of methods to secure the motorcycle in a standing position, but with varying degrees of success. For example, stands that engage the motorcycle's front wheel may be prone to allowing too much freedom of movement to the motorcycle and thus fail to adequately secure the motorcycle. Stands that secure the rear wheel of the motorcycle are often more difficult to use, as the rider must either back into the stand or must dismount and attempt to hold the motorcycle steady while attaching or using the stand. Central lift stands that support the motorcycle by the body tend to have more moving parts and require special movements to engage the stands. Thus, existing motorcycle stands fail to adequately address the needs of the motorcycle community.

### BRIEF SUMMARY OF THE INVENTION

Implementation of the invention provides a motorcycle stand that is simple to use, does not require any moving parts, and that adequately supports a motorcycle in an upright position by supporting the motorcycle at the motorcycle body. The motorcycle stand is easy to use, allowing rapid and easy engagement with the stand and rapid removal from the stand without requiring unnecessary motion, as the motorcycle is simply pushed forward onto the stand and pulled backward off the stand. The forward or backward motion of the motorcycle causes rotational movement of at least a portion of the motorcycle stand, which may include some translational movement of the motorcycle stand across an underlying surface.

At least some implementations of the motorcycle stand include one or more surfaces or supports that serve to engage portions of a motorcycle as the motorcycle stand is actuated as well as when the motorcycle stand is supporting the motorcycle. The one or more surfaces or supports first engage the front wheel of the motorcycle as the motorcycle is pushed onto/over the motorcycle stand. This engagement of the front wheel causes at least a portion of the motorcycle stand to begin rotating as the front wheel continues over the motorcycle stand. As the motorcycle continues moving forward over the motorcycle stand, the one or more surfaces or supports contact or engage the body of the motorcycle behind the front wheel. This contact ensures that the motorcycle stand or portion thereof continues to rotate as the motorcycle is continued to be pushed forward.

As the motorcycle continues forward, at least a portion of the one or more surfaces or at least two of the supports rotate to be underneath the motorcycle body, thereby supporting the motorcycle in an upright position. Meanwhile, the rotation of the motorcycle stand or portion thereof causes an opposite horizontal support to engage the ground, providing a natural stopping point for the rotation of the motorcycle stand. If the motorcycle is not completely supported by the stand at this point, the motorcycle is pushed forward slightly until it is properly supported. The entire process for engaging the stand can be accomplished in one quick and smooth movement of pushing the motorcycle forward.

One implementation of the invention provides a motorcycle stand having a motorcycle engaging and supporting element for engaging and supporting a motorcycle when the motorcycle stand is in a motorcycle-supporting position in which the motorcycle engaging and supporting element is elevated above an underlying surface. The motorcycle stand includes a rotational motion driving element configured to engage a portion of a motorcycle being pushed onto the stand to cause rotation of at least a portion of the stand between a ready position in which the motorcycle engaging and supporting element is proximate the underlying surface and the motorcycle-supporting position and a rotational guiding element operatively connected to the motorcycle engaging element and the rotational motion driving element so as to guide rotation of the at least a portion of the motorcycle stand between the motorcycle-supporting position and the ready position.

The motorcycle engaging and supporting element may include a first strut and a second strut. The rotational motion driving element may be a third strut. The implementation of the motorcycle stand may further include two relationship elements connected to and maintaining the relationships between the motorcycle engaging and supporting element, the rotational motion driving element, and the rotational guiding element. Each relationship element forms a side element of the motorcycle stand, and the rotational guiding element may be formed as a part of the relationship elements.

In some implementations, each relationship element includes a side piece having a pair of opposing flat surfaces configured so that when one of the opposing flat surfaces contacts an underlying surface, the opposing flat surface is approximately parallel to the underlying surface and a curved surface forming the rotational guiding element and connecting the pair of opposing flat surfaces along a curved path. The side pieces may be side frames having a first straight portion forming one of the opposing flat surfaces, a second straight portion forming the other opposing flat surface, and a curved portion connected to the first straight portion and the second straight portion and comprising the curved surface. The curved surface and at least one of the opposing flat surfaces optionally includes a frictional surface.

In some implementations, the rotational motion driving element and the motorcycle engaging and supporting element comprise a substantially-continuous surface extending along an at least partially-curved path.

In another implementation, a rotating motorcycle stand includes a pair of side elements, each side element having a first portion configured to contact and rest upon an underlying surface when the stand is in a ready position. Each side element also includes a second portion configured to contact and rest upon the underlying surface when the stand is in a motorcycle-supporting position, wherein any surfaces of the first portion configured to contact the underlying surface in the ready position are approximately parallel to any surfaces of the second portion configured to contact the underlying surface in the motorcycle-supporting position. The side elements also have a curved portion connected to and extending between the first portion and the second portion along a curved path that permits substantially-smooth rolling of the side elements between the ready position and the motorcycle-supporting position.

The rotating motorcycle stand of this implementation includes a motorcycle-supporting element connected to and extending between the two side elements at a location proximate the first portion of the side elements, and a rotational motion driving element connected to and extending between the two side elements at a location proximate the curved portion and in between the first portion and the second portion of the side elements, thereby being elevated above the motorcycle-supporting element when the stand is in the ready position.

In another implementation, a rotating motorcycle stand includes a first side frame and a second side frame, each side frame having a first straight portion, a second straight portion approximately parallel to the first straight portion, and a curved portion connected to and extending between the first straight portion and the second straight portion along a curved, substantially-continuous path. A first strut extends between and is connected to the first straight portion of each side frame at a location distal the curved portion. A second strut extends between and is connected to the first straight portion of each side frame at a location proximal the curved portion. A third strut extends between and is connected to the curved portion of each side frame at a location intermediate the first straight portion and the second straight portion.

In some forms of this implementation, the third strut has a length longer than at least one of a length of the first strut and a length of the second strut, whereby respective planes of the first side frame and the second side frame are non-parallel to each other. Portions of the various embodiments of the motorcycle stand may be include materials such as plastic, wood, fiberglass, carbon fiber, composite materials, and metals, including tubular and solid materials, as appropriate. The various implementations of the invention are therefore described in more detail herein with respect to the accompanying Figures which are incorporated by reference.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a perspective view of one embodiment of a motorcycle stand;

FIG. 2 shows an alternate perspective view of the motorcycle stand of FIG. 1;

FIG. 3 shows a perspective view of an embodiment of a motorcycle stand;

FIG. 4 shows a perspective view of an embodiment of a motorcycle stand;

FIG. 5 shows a perspective view of an embodiment of a motorcycle stand;

FIG. 6 shows a perspective view of a portion of an embodiment of a motorcycle stand;

FIG. 7 shows a series of perspective views of a motorcycle engaging an embodiment of a motorcycle stand;

FIG. 8 shows a perspective conceptualized view of an alternate embodiment of a motorcycle stand in a ready position; and

FIG. 9 shows a perspective conceptualized view of the embodiment of FIG. 8 in a motorcycle-supporting position.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide a motorcycle stand that is simple to use, does not require any moving parts, and that adequately supports a motorcycle in an upright position by supporting the motorcycle at the motorcycle body. The motorcycle stand is easy to use, allowing rapid and easy engagement with the stand and rapid removal from the stand without requiring unnecessary motion, as the motorcycle is simply pushed forward onto the stand and pulled backward off the stand. The forward or backward motion of the motorcycle causes rotational movement of at least a portion of the motorcycle stand, which may include some translational movement of the motorcycle stand across an underlying surface.

The motorcycle stand includes one or more surfaces, supports, or other structures that serve to engage portions of a motorcycle as the motorcycle stand is actuated as well as when the motorcycle stand is supporting the motorcycle. The one or more surfaces or supports first engage the front wheel of the motorcycle as the motorcycle is pushed onto/over the motorcycle stand. This engagement of the front wheel causes at least a portion of the motorcycle stand to begin rotating as the front wheel continues over the motorcycle stand. As the motorcycle continues moving forward over the motorcycle stand, the one or more surfaces or supports contact or engage the body of the motorcycle behind the front wheel. This contact ensures that the motorcycle stand or portion thereof continues to rotate as the motorcycle is continued to be pushed forward.

As the motorcycle continues forward, at least a portion of the one or more surfaces or at least two of the supports rotate to be underneath the motorcycle body, thereby supporting the motorcycle in an upright position. Meanwhile, the rotation of the motorcycle stand or portion thereof causes an opposite horizontal support to engage the ground, providing a natural stopping point for the rotation of the motorcycle stand. If the motorcycle is not completely supported by the stand at this point, the motorcycle is pushed forward slightly until it is properly supported. The entire process for engaging the stand can be accomplished in one quick and smooth movement of pushing the motorcycle forward.

Some embodiments of the a motorcycle stand have a motorcycle engaging and supporting element for engaging and supporting a motorcycle when the motorcycle stand is in a motorcycle-supporting position in which the motorcycle engaging and supporting element is elevated above an underlying surface. The motorcycle stand includes a rotational motion driving element configured to engage a portion of a motorcycle being pushed onto the stand to cause rotation of at least a portion of the stand between a ready position in which the motorcycle engaging and supporting element is proximate the underlying surface and the motorcycle-supporting position and a rotational guiding element operatively connected to the motorcycle engaging element and the rotational motion driving element so as to guide rotation of the at least a portion of the motorcycle stand between the motorcycle-supporting position and the ready position.

The motorcycle engaging and supporting element may include a first strut and a second strut. The rotational motion driving element may be a third strut. The embodiments of the motorcycle stand may further include two relationship elements connected to and maintaining the relationships between the motorcycle engaging and supporting element, the rotational motion driving element, and the rotational guiding element. Each relationship element forms a side element of the motorcycle stand, and the rotational guiding element may be formed as a part of the relationship elements.

In some embodiments, each relationship element includes a side piece having a pair of opposing flat surfaces configured so that when one of the opposing flat surfaces contacts an underlying surface, the opposing flat surface is approximately parallel to the underlying surface and a curved surface forming the rotational guiding element and connecting the pair of opposing flat surfaces along a curved path. The side pieces may be side frames having a first straight portion forming one of the opposing flat surfaces, a second straight portion forming the other opposing flat surface, and a curved portion connected to the first straight portion and the second straight portion and comprising the curved surface. The curved surface and at least one of the opposing flat surfaces optionally includes a frictional surface.

In some embodiments, the rotational motion driving element and the motorcycle engaging and supporting element comprise a substantially-continuous surface extending along an at least partially-curved path. This substantially-continuous surface may

In other embodiments, a rotating motorcycle stand includes a pair of side elements, each side element having a first portion configured to contact and rest upon an underlying surface when the stand is in a ready position. Each side element also includes a second portion configured to contact and rest upon the underlying surface when the stand is in a motorcycle-supporting position, wherein any surfaces of the first portion configured to contact the underlying surface in the ready position are approximately parallel to any surfaces of the second portion configured to contact the underlying surface in the motorcycle-supporting position. The side elements also have a curved portion connected to and extending between the first portion and the second portion along a curved path that permits substantially-smooth rolling of the side elements between the ready position and the motorcycle-supporting position.

The rotating motorcycle stand of such embodiments includes a motorcycle-supporting element connected to and extending between the two side elements at a location proximate the first portion of the side elements, and a rotational motion driving element connected to and extending between the two side elements at a location proximate the curved portion and in between the first portion and the second portion of the side elements, thereby being elevated above the motorcycle-supporting element when the stand is in the ready position.

In other embodiments, a rotating motorcycle stand includes a first side frame and a second side frame, each side frame having a first straight portion, a second straight portion approximately parallel to the first straight portion, and a curved portion connected to and extending between the first straight portion and the second straight portion along a curved, substantially-continuous path. A first strut extends between and is connected to the first straight portion of each side frame at a location distal the curved portion. A second strut extends between and is connected to the first straight portion of each side frame at a location proximal the curved portion. A third strut extends between and is connected to the curved portion of each side frame at a location intermediate the first straight portion and the second straight portion.

In some forms of such embodiments, the third strut has a length longer than at least one of a length of the first strut and a length of the second strut, whereby respective planes of the first side frame and the second side frame are non-parallel to each other.

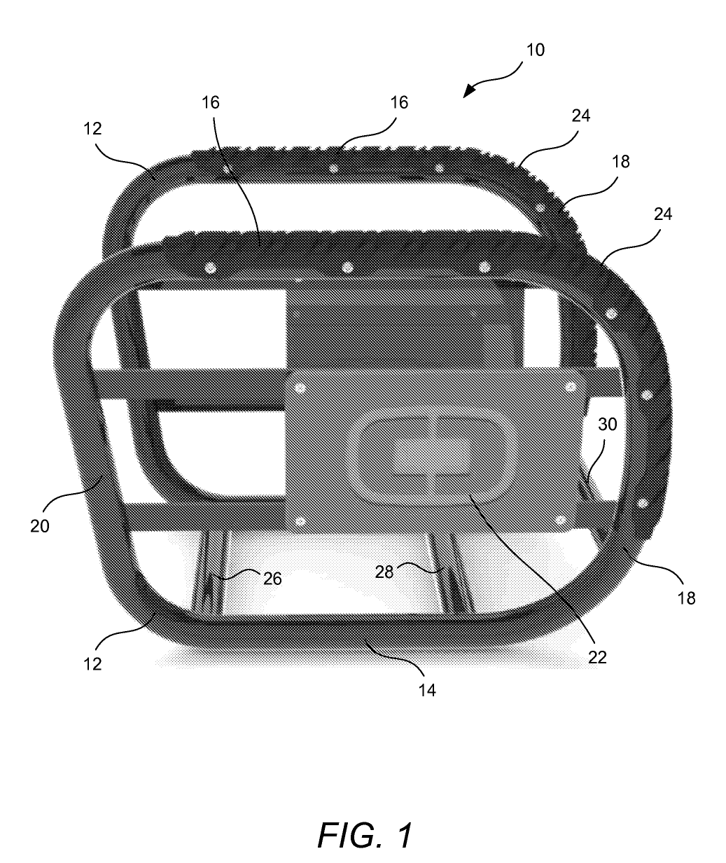

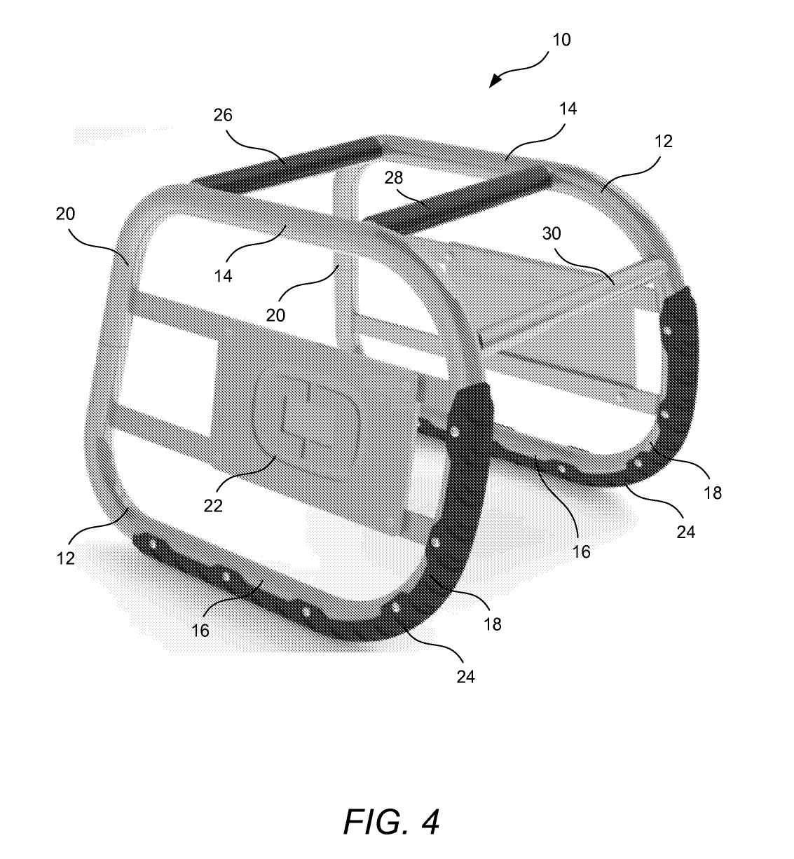

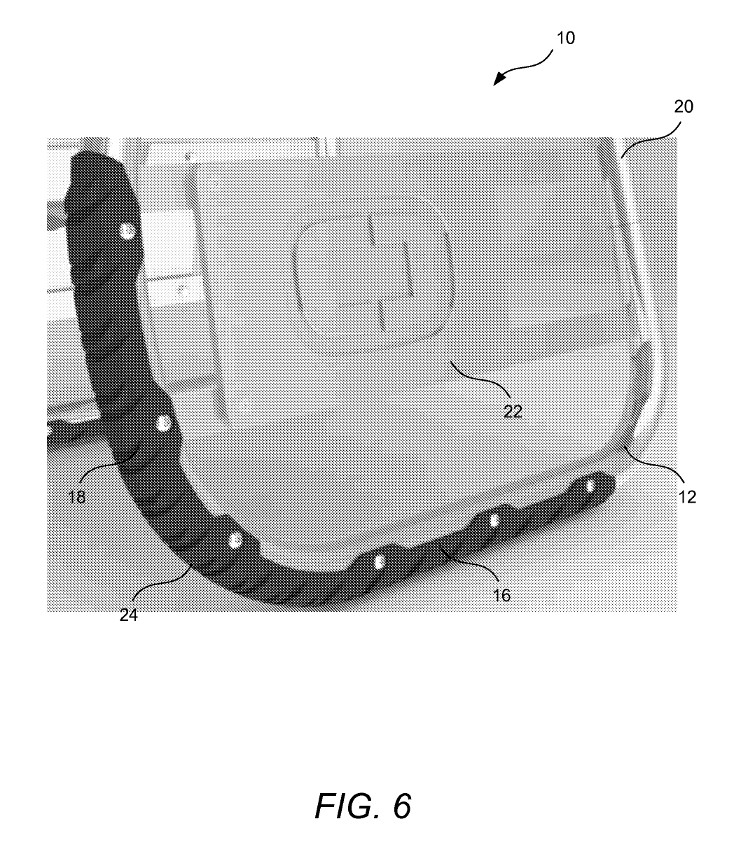

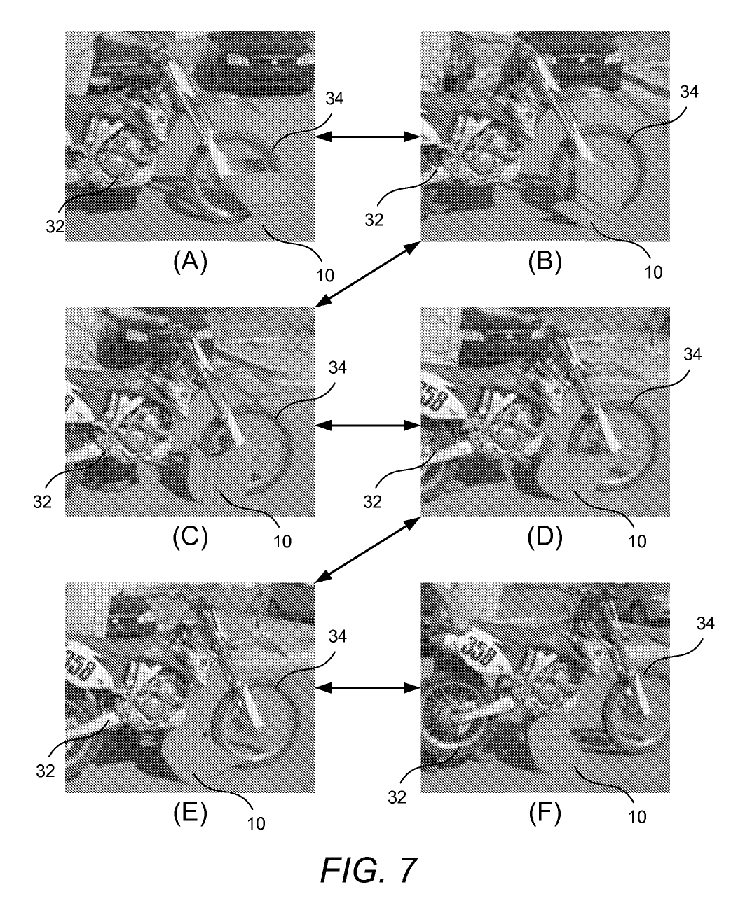

FIGS. 1-6 provide various perspective views of representative embodiments of a motorcycle stand 10. The illustrated embodiments are rolling motorcycle stands 10 in that they roll as the motorcycle engages and is supported by the motorcycle stand 10, as will be discussed further below with respect to FIG. 7. The illustrated embodiments are to be considered merely illustrative of the forms that the motorcycle stand 10 may take, and therefore the invention is not considered to be limited to the specific forms illustrated in FIGS. 1-7. With reference to FIGS. 1-6, these embodiments of the motorcycle stand 10 include two side frames 12. The side frames 12 are one example of side elements and/or relationship elements in accordance with embodiments of the invention as set forth in the claims. The side frames 12 may take one of many functional and decorative shapes, although the functions achieved by the rolling motorcycle stand embodiments are illustrated by the shapes of the side frames 12 shown in FIGS. 1-6.

In this regard, the side frames 12 include a first straight portion 14 and a second straight portion 16. The first straight portion 14 and the second straight portion 16 are substantially or approximately parallel in the illustrated embodiments, that is, when the first straight portion 14 is resting fully on the ground or some other underlying surface, the second straight portion 16 is substantially or approximately parallel to the ground or other underlying surface, and when the second straight portion 16 is resting fully on the ground or some other underlying surface, the first straight portion 14 is substantially or approximately parallel to the ground or other underlying surface. Although the first straight portion 14 and the second straight portion 16 are illustrated in the referenced embodiments, it is envisioned that other embodiments may include portions similar to the first straight portion 14 and the second straight portion 16 that are substantially non-parallel or that include non-parallel portions. For example, non-parallel portions may be used to provide appropriate angles to contact and support a particular type of motorcycle in the manner discussed herein. As another example, non-parallel portions may be introduced for decorative or other purposes. Thus, the first straight portion 14 and the second straight portion 16 should be considered examples of possible first portions and second portions discussed herein only, and references herein to first and second portions should not be construed as being limited to portions that are straight.

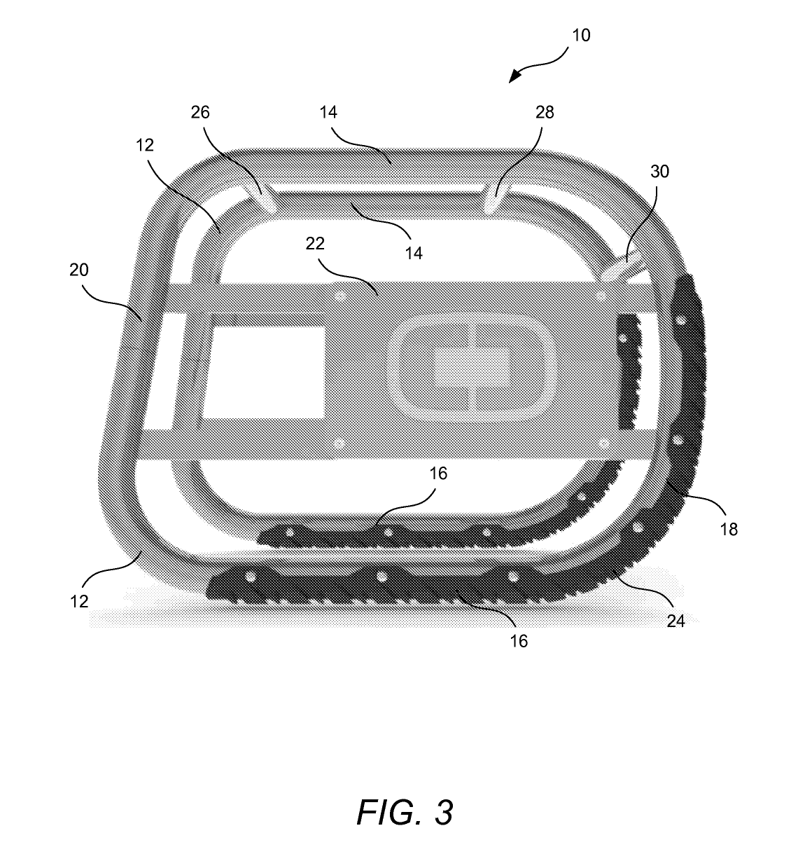

The first straight portion 14 of each side frame 12 is connected to the second straight portion 16 by a curved portion 18. The curved portion 18 extends between the first straight portion 14 and the second straight portion 16, making a curved, substantially-continuous path between the first straight portion 14 and the second straight portion 16. As the motorcycle stand 10 is used, the curved portion 18 of each side frame 12 contacts the ground as the motorcycle stand 10 is transitioned from a first position (as shown in FIGS. 1, 2, and 5) where the first straight portion 14 of the side frames 12 is resting on the ground, to a second position (as shown in FIGS. 3, 4, and 6) where the second straight portion 16 of the side frames 12 is resting on the ground. Thus, the curved portion 18 and/or the curved, substantially-continuous path are examples of a rotational guiding element as used herein.

This transition and motion is illustrated in FIG. 7, and will be discussed in more detail later. The first position shown in FIGS. 1, 2, and 5 illustrates an example of a ready position in which a motorcycle engaging and supporting element is proximate an underlying surface. The second position shown in FIGS. 3, 4, and 6 illustrates an example of a motorcycle-supporting position in which a motorcycle engaging and supporting element is elevated above the underlying surface.

The side frames 12 may include additional elements beyond the first straight portion 14, the second straight portion 16, and the curved portion 18. For example, the ends of the first straight portion 14 and the second straight portion 16 opposite the curved portion 18 may be connected to each other by a connecting portion 20. The connecting portion 20 may serve to increase the strength of the side frame 12, but otherwise does not serve a purpose in the motion/transitioning of the motorcycle stand 10; therefore, the shape/curve of the connecting portion 20 may be varied as desired, or the connecting portion 20 may be omitted, as long as any desired strength characteristics of the motorcycle stand 10 are maintained/provided by other elements.

The side frames 12 may be made of any desired material sufficiently durable and strong to provide the functionalities discussed herein, such as tubular or solid aluminum or steel or alloys thereof, many types of hollow or solid plastics, woods, other metals, fiberglass, carbon fiber, composite materials, etc. For example, in the embodiments illustrated in FIGS. 1-6, each side frame 10 is manufactured of a single length of painted tubular steel, which has been bent into the illustrated shape to form the first straight portion 14, the curved portion 18, the second straight portion 16, and the connecting portion 20. The side frames 12 may also include one or more decorative elements 22, which may optionally simultaneously provide structural rigidity or support to the side frames 12, or which may be purely decorative.

As may be appreciated from the illustrated side frames 12 and the description of the various embodiments of the invention, in some embodiments, the side frames 12 may be replaced by other planar, substantially-planar, and non-planar side elements that maintain the functionality of the embodiments of the invention. For example, in one embodiments, the side frames are replaced by a solid side element, which may be made of metal or may be formed or molded from plastic or some other material or may be carved from wood, etc. The solid side element may not have spaces between portions of the side element, as the side frame 10 has spaces between the first straight portion 14 and the second straight portion 16, etc. Instead, embodiments of the solid side element include a first straight surface and a second straight surface, which surfaces are approximately or substantially parallel (or non-parallel as necessary to provide the functionality discussed herein with respect to a particular motorcycle) so that when the first straight surface is resting on the ground or some other smooth surface, the second straight surface is substantially parallel to the ground or other smooth surface, and vice-versa. The solid side element also includes a curved surface connecting the first straight surface and the second straight surface in the manner of the curved portion 18 discussed above. By way of illustration, the motorcycle stand 10 illustrated in the views of FIG. 7 includes one example of a solid side element instead of a side frame 12.

It should be understood that any combination or modification of the solid side element and/or side frame 12 is embraced by embodiments of the invention. For example, while a solid side element is illustrated in the views of FIG. 7 that is completely contiguous, it is envisioned that the solid side element could include one or more holes, notches, or the like, for various purposes including decorative purposes. Additionally, in some embodiments, a portion of the side element may be solid while another portion may be provided by a frame or frame portion similar to a portion of the side frame 12.

It should also be noted that various curvatures of the curved portion 18 or curved surface discussed above may be used. For example, the curved path of the curved portion 18 illustrated in FIGS. 1-6 is different than the curved path of the curved surface illustrated in the views of FIG. 7. It is anticipated that a wide variety of curvatures/curved paths may be used to connect the first and second straight portions/surfaces while maintaining the functionality of the embodiments of the invention.

It will also be noted that a frictional surface 24 may optionally be provided to the side frames 12 or side elements. The frictional surface 24 may be formed of any desired material and attached to the side frames 12 or side elements in any desired fashion. Illustrative materials include natural or synthetic rubber or rubber-like materials, and soft plastics, as well as abrasions or other frictional surfaces formed directly into the side frame 10 or side element, etc. The frictional surface 24 may assist in providing good non-sliding contact between the motorcycle stand 10 (particularly the side frames 12 or other side elements) and the ground. Thus, the frictional surface 24 may optionally be limited to only the curved portion 18 and the second straight portion 16 (or the corresponding first straight surface and the corresponding curved surface).

Although the first straight portion 14 and the second straight portion 16 (or the corresponding first and second straight surfaces) have been described as being substantially straight, it is emphasized that these elements need not be completely solid or straight. For example, the second straight portion 16 need not be particularly straight in many embodiments. Instead, for whatever reason, including decorative reasons, the second straight portion 16 may not be straight but may include curved portions. In some such embodiments, the second straight portion 16 has at least two contacting portions that are located and configured to contact the ground such that when both contacting portions are touching the ground or other substantially flat surface, the first straight portion 14 is substantially parallel to the ground or flat surface. Thus, in conjunction with the other possible variations discussed above, it may be understood that a very wide variety of shapes may be used for the side frames 12 or other side elements. Additionally, it should also be understood that the side frames 12 or other side elements need not necessarily be minor images or near-minor images of each other (as illustrated in FIGS. 1-6), but may be varied for decorative or other purposes.

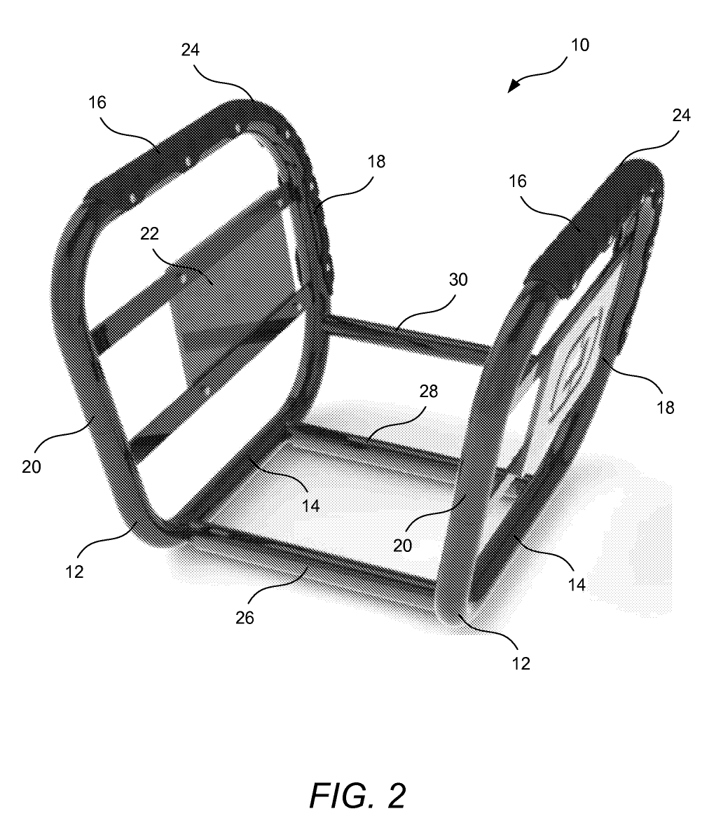

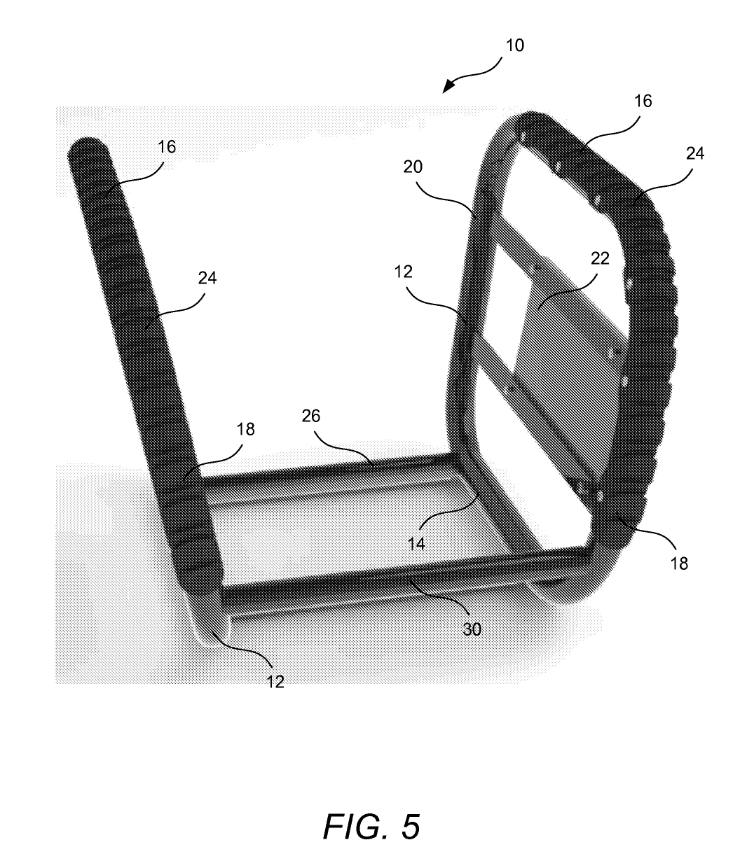

As illustrated in FIGS. 1-6, the side frames 12 (or other side elements) are connected to each other along at least a portion of the first straight portion 14 and at least a portion of the curved portion 18. In the embodiments illustrated in FIGS. 1-6, the connection is made using a first bar or strut 26 connecting the first straight portions 14 distal the curved portions 18 (and proximal the connecting portions 20), a second bar or strut 28 connecting the first straight portions 14 more proximal the curved portions 18 (and more distal the connecting portions 20), and a third bar or strut 30 connecting the curved portions proximal the first straight portions 14. The first bar or strut 26 and the second bar or strut 28 are one example of a motorcycle engaging and supporting element as used herein. The third bar or strut 30 is one example of a rotational motion driving element as used herein. In at least some embodiments, the third bar or strut 30 is somewhat longer than the first bar or strut 26 and the second bar or strut 28, which are substantially equal in length, whereby the side frames 12 angle outwardly. This outward angling is best illustrated in FIGS. 2 and 5.

This outward angling is one feature of some embodiments of the motorcycle stand 10. In other embodiments, the side frames 12 or other side elements are substantially parallel to each other. Nevertheless, the outward angling may serve several functions when present. First, the outward angling may make it easier for a motorcycle wheel to enter the motorcycle stand 10 without catching on the side frames 12 or other side elements, both as the motorcycle is pushed into/onto the motorcycle stand 10 and as the motorcycle is pushed/pulled off of/out of the motorcycle stand 10. Second, the outward angling causes the motorcycle stand 10 to have a broader base when supporting a motorcycle, inherently improving the stability of the motorcycle stand 10 and the supported motorcycle. Some users may find the aesthetics of the motorcycle stand 10 with outward angling pleasant, and other users may prefer the aesthetics of the motorcycle stand 10 with minimal to no outward angling, and embodiments may be provided with any degree of outward angling.

Although three bars or struts 26, 28, 30 have been illustrated in the embodiments shown in FIGS. 1-6, additional bars or struts may be provided in some embodiments. Additional bars or struts are examples of other motorcycle engaging and supporting elements. In still alternate embodiments, a contiguous surface or substantially-contiguous surface may be provided between locations roughly corresponding to the first bar or strut 26 and the second bar or strut 28. This is another example of a motorcycle engaging and supporting element. In still other embodiments, the third bar or strut 26 may be replaced by a surface that follows the curvature of the curved portion 18, as much as approximately half way up the curved portion 18. This is another example of an alternate rotational motion driving element. In still other embodiments, a continuous, not completely co-planar, surface may be provided between approximately the location of the first bar or strut 26 illustrated in FIGS. 1-6 and approximately the location of the third bar or strut 30 illustrated in FIGS. 1-6 or even extending further, such as approximately half way up the curved portion 18. This type of surface is an example of a contiguous motorcycle engaging and supporting element and a rotational motion driving element, all provided as one contiguous, curved surface.

The various bars, struts, or surfaces discussed above serve several functions, as will now be discussed with particular reference to FIG. 7. FIG. 7 shows a sequence of perspective views of a motorcycle 32 as it is pushed (following the sequence from A to F) onto an embodiment of the motorcycle stand 10 or, reversing the sequence (following from F to A), as it is pulled off of the motorcycle stand 10. To use the motorcycle stand 10, the first straight surface is resting on the ground, and a front wheel 34 of the motorcycle 32 is pushed into the motorcycle stand 10, entering the motorcycle stand 10 away from, and moving toward, the curved surface (A). As the front wheel 34 pushes into the third bar or strut 30 (or the equivalent, depending on the embodiment of the motorcycle stand 10), the weight of the motorcycle 32 begins to push down on the third bar or strut 30 (or equivalent), causing the motorcycle stand 10 to begin to rotate forward (B).

As the motorcycle 32 continues to move forward, the motorcycle stand 10 continues to rotate forward, until the front wheel 34 finishes passing over the third bar or strut 30 (or equivalent), when the first and second straight surfaces are pointing roughly upward from the ground and the curved surface is still contacting the ground (C). The motorcycle stand 10 continues rotating forward and/or remains with the first and second straight surfaces pointing roughly upward based on one or more of several principles. First, if the motorcycle 32 is moving forward with some speed, the rotational inertia imparted to the motorcycle stand 10 by the passage of the front wheel 34 will tend to continue to rotate the motorcycle stand 10. Second, the motorcycle stand 10 may be weighted or otherwise biased to remain in this position and/or to continue rotating. Third, the curved portion may be provided with a curvature or even a flattened portion that tends to continue the rotation of the motorcycle stand 10. Fourth, as the first bar or strut 26 (or other corresponding structure) is above the ground a significant amount in the rotated position, it is in a position to engage the forward-moving frame of the motorcycle 32 or some other fixed portion (e.g. motor) of the motorcycle 32 behind the front wheel 34.

As the frame, engine, etc. of the motorcycle 32 contacts the first bar or strut 26 (or other corresponding structure), the forward motion of the motorcycle 32 causes the motorcycle stand 10 to continue rotating (D). Thus, the first bar or strut 26 also aids in rotation of the motorcycle stand 10 and is another example of a rotational motion driving element. Then, as the motorcycle 32 continues moving forward and the motorcycle stand 10 continues rotating forward, the frame, engine, etc. of the motorcycle 32 begins to ride up on the first bar or strut 26 and/or the second bar or strut 28 (E), thus the first bar or strut 26 and/or the second bar or strut 28 (or equivalent) engages and begins to support the motorcycle 32.

Finally, as the second straight surface of the motorcycle stand 10 is fully contacting the ground, the first bar or strut 26 and the second bar or strut 28 (or other corresponding structures or surfaces) become horizontal to the ground, whereupon the motorcycle 32 is either resting on the first bar or strut 26 and the second bar or strut 28 or can be easily slid forward to rest upon the first bar or strut 26 and the second bar or strut 28 (F). In that regard, the frictional surface 24 (if present), may assist in keeping the motorcycle stand 10 securely in place while the motorcycle 32 slides the last bit forward, and the first bar or strut 26 and the second bar or strut 28 (or other corresponding structure or surface) may be made of a lower-friction material or may have a lower-friction motorcycle-contacting surface.

When the motorcycle is removed, the user begins pulling backward on the motorcycle 32 (F). The friction between the motorcycle 32 and the motorcycle stand 10 causes the motorcycle stand 10 to begin rotating backward (E). As the motorcycle 32 moves further backward, the motorcycle stand 10 continues to rotate backward (due to rotational inertia, etc.), and the rotation may be assisted in some embodiments by the rear portion of the front wheel 34 contacting and pushing backward on the first bar or strut 26 (or other corresponding structure). Eventually, the frame, motor, etc. of the motorcycle 32 leaves the motorcycle stand 10 (D), and the front wheel 34 enters the motorcycle stand 10, beginning to rest on the third bar or strut 30 (or corresponding structure/surface) (C).

As the motorcycle 32 continues to move backward, the front wheel pushes on the first bar or strut 26 and/or the second bar or strut 28 (or the corresponding structure or surface), continuing the backward rotation of the motorcycle stand 10 (B). Finally, the motorcycle stand 10 returns to its original position with the first straight surface contacting the ground, whereupon, backward rotation of the motorcycle stand substantially stops and the front wheel 34 of the motorcycle 32 rolls out of the motorcycle stand 10 backward.

As will be appreciated from the views of FIG. 7, this embodiment of the motorcycle stand 10 rolls across the ground or other underlying surface as the motorcycle 32 is pushed onto or pulled off of the motorcycle stand 10. This is a novel characteristic of some embodiments of the motorcycle stand, and is a characteristic that enables the motorcycle stand to be manufactured and used without necessarily including any moving parts. Moving parts may be included, such as to provide decorative elements that maintain their orientation relative to the ground or other underlying surface during rolling of the motorcycle stand 10, but such moving parts are not necessary for the motorcycle stand 10 to function to support the motorcycle 32.

When the motorcycle 32 is secured by the motorcycle stand 10 (as per (F) of FIG. 7), the motorcycle 32 may be lifted vertically somewhat by the motorcycle stand 10. Therefore, at least one of the wheels of the motorcycle 32 is lifted vertically off the ground. While, in some instances and embodiments, both wheels of the motorcycle 32 may be lifted off of the ground simultaneously and be maintained off of the ground by the motorcycle stand 10, the motorcycle stand 10 performs its function of maintaining the motorcycle 32 substantially upright in many instances even if only one wheel is lifted off the ground and the other wheel still contacts the ground. In such instances, the weight of the motorcycle 32 may cause the motorcycle 32 to tip slightly forward or slightly backward until one of the wheels contacts the ground.

Indeed, the motorcycle stand 10 may also tip slightly forward or backward with the motorcycle 32, or the motorcycle stand 10 may not tip with the motorcycle 32. If the motorcycle stand 10 tips slightly with the motorcycle 32, the entire second straight surface/second straight portion 16 may not be in contact with the ground. Instead, only a portion of the second straight surface/second straight portion 16 of each lateral side of the motorcycle stand 10 will be in contact with the ground, while the wheel of the motorcycle 32 is also in contact with the ground. In this case, the two points of contact of the motorcycle stand 10 with the ground and the third point of the wheel form a stable tripod-type contact with the ground, which adequately stabilizes the motorcycle 32.

Thus, when the motorcycle 32 is being supported by the motorcycle stand 10, the motorcycle frame is typically in contact with the first bar or strut 26 and the second bar or strut 28 (or some other corresponding structure/surface, as discussed above). Commonly, no portion of the motorcycle 32 need contact any portion of the first straight portion 14 (or first straight surface, or other corresponding structure, as discussed above) of the motorcycle stand 10 while being supported by the motorcycle stand 10. Additionally, when the motorcycle 32 is being supported by the motorcycle stand 10, only a small portion of each second straight portion 16 (or corresponding structure) of the motorcycle stand 10 need contact the ground. Thus, the second straight portion 16 (or corresponding structure) need not be entirely straight and may be replaced by a curved element or a discontinuous element as desired for decorative or other reasons.

Meanwhile, when the motorcycle stand 10 is not supporting the motorcycle 32, it is held in a ready position to receive the front wheel 34 of the motorcycle 32 by the first straight portions 14 (or corresponding structure) of each side, but as this function may equally well be provided by a curved element or a discontinuous element as desired for decorative or other reasons, some embodiments may provide such features as desired for decorative or other reasons.

Finally, when the motorcycle stand 10 is being transitioned between the ready position and the supporting position, the rotation is guided by the curved portion 18 (or the curved surface or other corresponding structure as discussed above), as driven by the motorcycle wheel 34 and/or other structure of the motorcycle 32 engaging the third bar or strut 30 (or other structure or surface as discussed above) as well as the first bar or strut 26 (or other corresponding surface or structure as discussed above) and the second bar or strut 28 (or other corresponding surface or structure as discussed above). Thus, the curved portion serves as a rotational guiding element or rotational motion guiding element that guides the rotation of such embodiments of the motorcycle stand 10.

Thus, functional elements of some embodiments of the motorcycle stand 10 include 1) a motorcycle engaging and supporting element or structure or means for engaging and supporting a motorcycle when the motorcycle stand 10 is in a motorcycle-supporting position (e.g. some structure or element corresponding to the first bar or strut 26 and the second bar or strut 28); 2) a rotational motion driving structure or element or means for driving rotation of the motorcycle stand 10 between a ready position and the motorcycle-supporting position and vice-versa (e.g. some structure or element primarily corresponding to the third bar or strut 30 and potentially corresponding to one or more of the first bar or strut 26 and the second bar or strut 28); 3) a rotational guiding structure or element or means for guiding rotation of the motorcycle stand 10 between the motorcycle-supporting position and the ready position and vice-versa (e.g. some structure or element corresponding to the curved portion 18 or curved surface discussed above). Embodiments of the motorcycle stand 10 also include 4) a structure, element, or means for maintaining the relationships between the first three elements (such as the side frames 12, the side elements, etc. discussed above).

As discussed above, certain embodiments of the invention are characterized by rotation of at least a portion the motorcycle stand 10 driven by engagement of the front wheel 34 of the motorcycle 32 (and potentially other structures of the motorcycle 32) as the motorcycle 32 is pushed onto or pulled off of the motorcycle stand 10. In many such embodiments, the rotation of at least a portion of the motorcycle stand is accompanied by translational rolling of the motorcycle stand 10 across an underlying surface such as the ground. Other embodiments are envisioned where at least a portion of the motorcycle stand 10 rotates driven by engagement of the front wheel 34 of the motorcycle 32 (and potentially other structures of the motorcycle 32) and where this portion supports the motorcycle in a similar motorcycle-supporting position, but where such rotation is not accompanied by translational rolling of the entire motorcycle stand 10 across an underlying surface. Instead, the motorcycle stand 10 of such embodiments remains in an essentially fixed position, and the motorcycle 32 is pushed through this fixed position to engage the motorcycle stand 10.

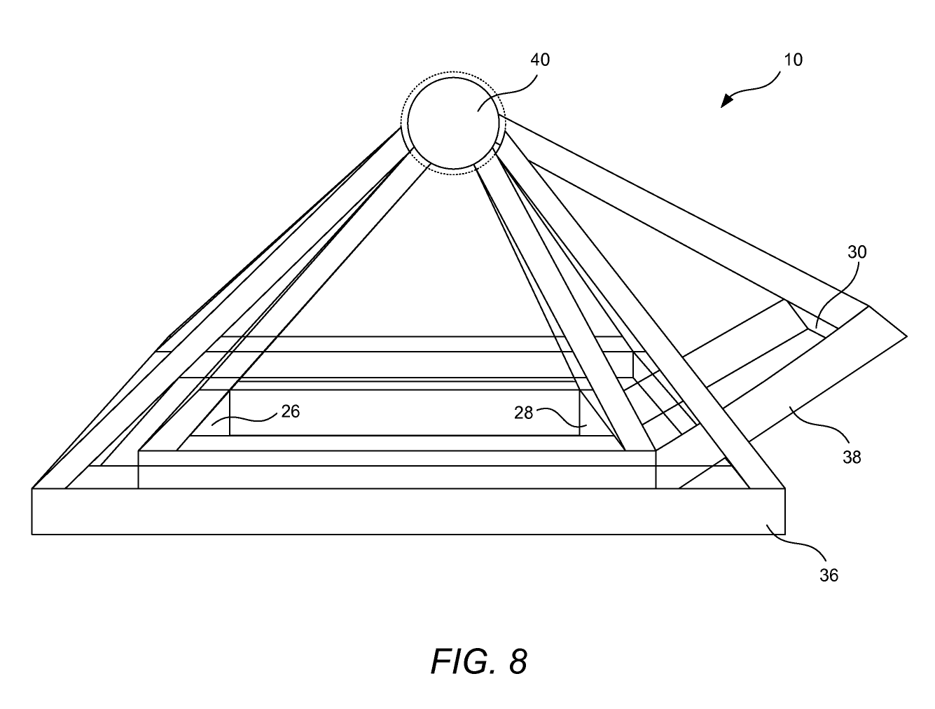

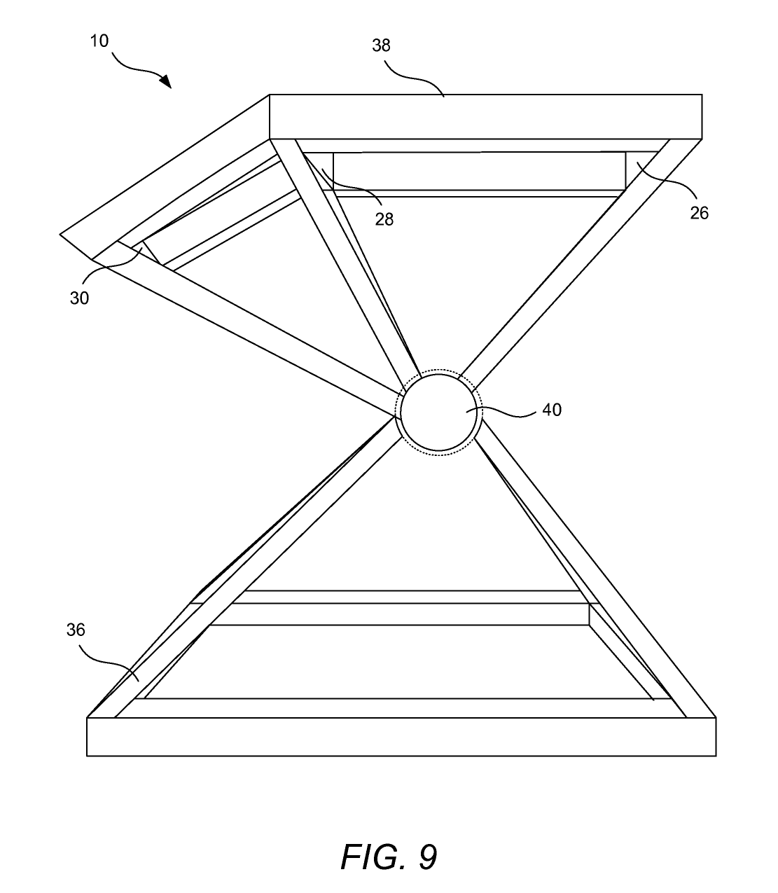

Some such embodiments incorporate several parts that move/rotate in relation to each other. One such embodiment is conceptually illustrated in FIGS. 8 and 9. This embodiment includes a base frame 36 that rests more or less fixedly on an underlying surface. The base frame 36 is rotationally mounted to a motorcycle-supporting frame 38 at a rotational joint 40 on each side of the motorcycle stand 10. The rotational joint 40 is elevated above the ground approximately half the desired height of the motorcycle stand 10 in the motorcycle-supporting position, and is another example of a rotational guiding element or rotational motion guiding element. The motorcycle-supporting frame 38 includes a first bar or strut 26, a second bar or strut 28, and a third bar or strut 30, or corresponding structures or surfaces, just as with other embodiments previously described (providing the motorcycle engaging and supporting element and the rotational motion driving element, as discussed above). However, in this embodiment, no portion of the motorcycle-supporting frame 38 contacts the underlying surface during the entire use of the motorcycle stand 10.

Instead, the motorcycle-supporting frame 38 is slightly elevated above the underlying surface when the motorcycle stand 10 is in the ready position illustrated in FIG. 8. Then, as the motorcycle 32 is pushed onto the motorcycle stand 10, the front wheel 34 rides up on the base frame 36 and then the first bar or strut 26 and in between the two rotational joints 40. As the motorcycle 32 continues its forward motion, the front wheel 34 engages and rides up on the third bar or strut 30, which causes the motorcycle-supporting frame 38 to rotate in a clockwise direction (as viewed in FIGS. 8 and 9) relative to the base frame 36 until the motorcycle 32 has been pushed forward sufficiently that the third bar or strut 30 has been pushed down and back behind the front wheel 34, thus pushing the first bar or strut 26 upward where it can engage (and eventually begin to support the motorcycle frame, engine, etc., as rotation of the motorcycle-supporting frame 38 continues.

The rotational joint 40 may be provided with a frictional mechanism to prevent un-forced, un-wanted reverse rotation of the motorcycle-supporting frame 38 relative to the base frame 36 until the motorcycle body, engine, etc. engages and begins pushing forward on the first bar or strut 26 to continue the clockwise rotation of the motorcycle-supporting frame 38 relative to the base frame 36. The continued forward motion of the motorcycle 32 completes rotation of the motorcycle-supporting frame 38 until the motorcycle stand 10 is in the motorcycle-supporting position shown in FIG. 9. The motorcycle is maintained in the supported position as one of the two wheels of the motorcycle rests upon the ground. While this embodiment is somewhat more complex than the previously-discussed embodiments, it utilizes many of the same principles and has the advantage of remaining in substantially one location as the motorcycle 32 is pushed into or pulled out of the motorcycle stand 10, and the base frame may even be fixedly attached to an underlying surface for additional stability and support against unwanted movement.

The previously-discussed embodiments rely on the transfer of energy from momentum of the motorcycle and/or from the user pushing the motorcycle into the motorcycle stand 10 to generate rotational movement of at least a portion of the motorcycle stand 10. Other embodiments are envisioned that utilize a different source of energy to generate similar rotational movement of at least a portion of the motorcycle stand 10. In some such embodiments, rotational movement of at least a portion of the motorcycle stand 10 is activated or triggered by the front wheel of a motorcycle passing through the motorcycle stand 10. After the rotational movement is triggered or otherwise activated, it may be powered/driven by energy supplied and/or stored in one or more springs, pneumatic cylinders, and/or hydraulic cylinders. In such embodiments, the rotational movement may be primarily driven by such stored or supplied energy, or it may be assisted by momentum of the motorcycle or by someone pushing the motorcycle. As with other discussed embodiments, the rotational motion of at least a portion of the motorcycle stand 10 engages and lifts/supports at least a portion of the motorcycle.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A motorcycle stand comprising:
a motorcycle engaging and supporting element for engaging and supporting a motorcycle when the motorcycle stand is in a motorcycle-supporting position in which the motorcycle engaging and supporting element is elevated above an underlying surface;
a rotational motion driving element configured to engage a portion of a motorcycle being pushed onto the stand to cause rotation of at least a portion of the stand between a ready position in which the motorcycle engaging and supporting element is proximate the underlying surface and the motorcycle-supporting position; and
a rotational guiding element operatively connected to the motorcycle engaging element and the rotational motion driving element so as to guide rotation of the at least a portion of the motorcycle stand between the motorcycle-supporting position and the ready position.

2. A rotating motorcycle stand as recited in claim 1, wherein the motorcycle engaging and supporting element comprises:
a first strut; and
a second strut.

3. A rotating motorcycle stand as recited in claim 2, wherein the rotational motion driving element comprises a third strut.

4. A rotating motorcycle stand as recited in claim 1, wherein the motorcycle stand further comprises two relationship elements connected to and maintaining the relationships between the motorcycle engaging and supporting element, the rotational motion driving element, and the rotational guiding element.

5. A rotating motorcycle stand as recited in claim 4, wherein each relationship element forms a side element of the motorcycle stand.

6. A rotating motorcycle stand as recited in claim 5, wherein the rotational guiding element is formed as a part of the relationship elements.

7. A rotating motorcycle stand as recited in claim 6, wherein each relationship element comprises a side piece comprising:
a pair of opposing flat surfaces configured so that when one of the opposing flat surfaces contacts an underlying surface, the opposing flat surface is approximately parallel to the underlying surface; and
a curved surface forming the rotational guiding element and connecting the pair of opposing flat surfaces along a curved path.

8. A rotating motorcycle stand as recited in claim 7, wherein the side pieces are solid side pieces.

9. A rotating motorcycle stand as recited in claim 8, wherein the solid side pieces comprise a material selected from the group consisting of:
plastic;
wood;
fiberglass;
carbon fiber;
a composite material; and
metal.

10. A rotating motorcycle stand as recited in claim 7, wherein the side pieces are side frames comprising:
a first straight portion forming one of the opposing flat surfaces;
a second straight portion forming the other opposing flat surface; and
a curved portion connected to the first straight portion and the second straight portion and comprising the curved surface.

11. A rotating motorcycle stand as recited in claim 10, wherein the side frames comprise a material selected from the group consisting of:
plastic;
carbon fiber;
a composite material;
fiberglass;
tubular metal; and
solid metal.

12. A rotating motorcycle stand as recited in claim 7, wherein the curved surface and at least one of the opposing flat surfaces comprise a frictional surface.

13. A rotating motorcycle stand as recited in claim 1, wherein the rotational motion driving element and the motorcycle engaging and supporting element comprise a substantially-continuous surface extending along an at least partially-curved path.

14. A rotating motorcycle stand comprising:
a pair of side elements, each side element comprising:
a first portion configured to contact and rest upon an underlying surface when the stand is in a ready position;
a second portion configured to contact and rest upon the underlying surface when the stand is in a motorcycle-supporting position, wherein any surfaces of the first portion configured to contact the underlying surface in the ready position are approximately parallel to any surfaces of the second portion configured to contact the underlying surface in the motorcycle-supporting position; and
a curved portion connected to and extending between the first portion and the second portion along a curved path that permits substantially-smooth rolling of the side elements between the ready position and the motorcycle-supporting position;
a motorcycle-supporting element connected to and extending between the two side elements at a location proximate the first portion of the side elements; and
a rotational motion driving element connected to and extending between the two side elements at a location proximate the curved portion and in between the first portion and the second portion of the side elements, thereby being elevated above the motorcycle-supporting element when the stand is in the ready position.

15. A rotating motorcycle stand as recited in claim 14, wherein the motorcycle supporting element and the rotational motion driving element form a substantially-continuous and curved surface.

16. A rotating motorcycle stand as recited in claim 14, wherein the motorcycle-supporting element comprises a first strut and a second strut connected to and extending between the side elements, and wherein the rotational motion driving element comprises a third strut connected to and extending between the side elements.

17. A rotating motorcycle stand as recited in claim 14, wherein the side elements are closer to each other at the respective first portions than at the respective second portions.

18. A rotating motorcycle stand comprising:
a first side frame and a second side frame, each side frame comprising:
a first straight portion;
a second straight portion approximately parallel to the first straight portion; and
a curved portion connected to and extending between the first straight portion and the second straight portion along a curved, substantially-continuous path;
a first strut extending between and connected to the first straight portion of each side frame at a location distal the curved portion;
a second strut extending between and connected to the first straight portion of each side frame at a location proximal the curved portion; and
a third strut extending between and connected to the curved portion of each side frame at a location intermediate the first straight portion and the second straight portion.

19. A rotating motorcycle stand as recited in claim 18, wherein the third strut has a length longer than at least one of a length of the first strut and a length of the second strut, whereby respective planes of the first side frame and the second side frame are non-parallel to each other.

20. A rotating motorcycle stand as recited in claim 19, further comprising a frictional surface provided to at least the second straight portion and a portion of the curved portion.
